(19) United States
(12) Patent Application Publication
(10) Pub. No.: US 2016/0112508 A1
(43) Pub. Date: Apr. 21, 2016

(54) SYSTEM AND METHOD FOR CREATING, MANAGING, SHARING, AND PUBLISHING A HIERARCHICAL LIST STRUCTURE

(71) Applicant: Centrallo LLC, New York, NY (US)

(72) Inventor: Michael J. Sher, New York, NY (US)

(73) Assignee: Centrallo LLC, New York, NY (US)

(21) Appl. No.: 14/885,667

(22) Filed: Oct. 16, 2015

Related U.S. Application Data
(60) Provisional application No. 62/064,758, filed on Oct. 16, 2014.

(51) Int. Cl. H04L 29/08; G06F 17/30; H04L 29/06

(52) U.S. Cl. CPC H04L 67/1089; H04L 67/141; H04L 67/42; G06F 17/30887

(57) ABSTRACT

Disclosed are systems, devices, and methods for creating, managing, sharing, and publishing a hierarchical list structure, an exemplary system comprising a server configured to host an application, and a first client device connected to the server via a network, the first client device configured to interface with the application hosted by the server to create a list including a sub-list, and associate one or more data elements with the sub-list, wherein the one or more data elements are entries of the sub-list, and the sub-list is an entry of the list, and wherein the list, the sub-list, and the data elements are stored on the server.

### PRIORITY CLAIM

The present application claims priority to and the benefit of the previously filed provisional application to Michael Sher, having U.S. Provisional Patent Application No. 62/064,758, entitled “SYSTEM AND METHOD FOR CREATING, MANAGING, SHARING AND PUBLISHING A HIERARCHICAL LIST STRUCTURE,” filed on Oct. 16, 2014, the entire contents thereof are incorporated herein by reference.

### BACKGROUND

1. Technical Field

The present disclosure relates to the creation, management, sharing, and publishing of hierarchical list structures, and, more particularly, to devices, systems incorporating such devices, and methods of creating, managing, sharing, and publishing hierarchical list structures having various linked elements organized into multiple levels.

2. Description of Related Art

There is known in the art various methods of taking notes and keeping notes in a notepad, or, in the digital equivalent, a listing application. However, this approach is inefficient because all notes have to be kept in a single list and cannot be further organized into multiple lists.

### SUMMARY

The present disclosure is directed at a system and method of a hierarchical list structure to create, organize, and maintain lists of multiple levels and including data elements and sub-lists and any levels. The disclosure further describes methods of sharing those lists at multiple levels and locking lists with passwords at various levels.

Provided in accordance with the present disclosure is a system for creating, managing, sharing, and publishing a hierarchical list structure.

In an aspect of the present disclosure, the system comprises a server configured to host an application, and a first client device connected to the server via a network, the first client device is configured to interface with the application hosted by the server to create a list including a sub-list, and associate one or more data elements with the sub-list, wherein the one or more data elements are entries of the sub-list, and the sub-list is an entry of the list, and wherein the list, the sub-list, and the data elements are stored on the server.

In another aspect of the present disclosure, the system further comprises a second client device, and the first client device is further configured to share the list with the second client device.

In a further aspect of the present disclosure, the system further comprises a third client device, and the first client device is further configured to share the sub-list with the third client device.

In another aspect of the present disclosure, the first client device is further configured to mark one of the data elements as a priority to make it a prioritized element, and the client device adds the prioritized element to a priorities view where the prioritized element can be viewed without navigating through the list and sub-list.

In a further aspect of the present disclosure, the first client device is further configured to lock the sub-list with a password, and the third client device is required to enter the password before being granted access to the locked sub-list.

In another aspect of the present disclosure, the first client device is further configured to publish the list to a social media platform, wherein the publication to the social media platform includes the list, the sub-list, and the data elements.

In a further aspect of the present disclosure, the first client device is further configured to update the list, the sub-list, and the data elements on the server with any changes made to any of the list, the sub-list, or the data elements via the first client device.

Provided in accordance with another embodiment of the present disclosure is a method of creating, managing, sharing, and publishing a hierarchical list structure.

In an aspect of the present disclosure, the method comprises creating, via a first client device, a list including a sub-list, and associating one or more data elements with the sub-list, wherein the one or more data elements are entries of the sub-list, and the sub-list is an entry of the list, and wherein the list, the sub-list, and the data elements are stored on a server.

In a further aspect of the present disclosure, the method further comprises sharing the list with a second client device.

In another aspect of the present disclosure, the method further comprises sharing the sub-list with a third client device.

In a further aspect of the present disclosure, the method further comprises marking one of the data elements as a priority to make it a prioritized element, and the prioritized element is added to a priorities view where the prioritized element can be viewed without navigating through the list and sub-list.

In another aspect of the present disclosure, the method further comprises locking the sub-list with a password, and the third client device is required to enter the password before being granted access to the locked sub-list.

In a further aspect of the present disclosure, the method further comprises publishing the list to a social media platform, and the publication to the social media platform includes the list, the sub-list, and the data elements.

In another aspect of the present disclosure, the method further comprises updating the list, the sub-list, and the data elements on the server with any changes made to any of the list, the sub-list, or the data elements via the first client device.

Provided in accordance with another embodiment of the present disclosure is a non-transitory computer-readable storage medium storing a program for creating, managing, sharing, and publishing a hierarchical list structure, the program including computer-executable instructions which, when executed by a processor, causes a first client device to create a list including a sub-list, and associate one or more data elements with the sub-list, wherein the one or more data elements are entries of the sub-list, and the sub-list is an entry of the list, and wherein the list, the sub-list, and the data elements are stored on a server.

In a further aspect of the present disclosure, the instructions further cause the first client device to share the list with a second client device.

In another aspect of the present disclosure, the instructions further cause the first client device to share the sub-list with a third client device.

In a further aspect of the present disclosure, the instructions further cause the first client device to mark one of the data elements as a priority to make it a prioritized element, and the prioritized element is added to a priorities view where the prioritized element can be viewed without navigating through the list and sub-list.

In another aspect of the present disclosure, the instructions further cause the first client device to lock the sub-list with a password, and the third client device is required to enter the password before being granted access to the locked sub-list.

In a further aspect of the present disclosure, the instructions further cause the first client device to update the list, the sub-list, and the data elements on the server with any changes made to any of the list, the sub-list, or the data elements via the first client device.

### BRIEF DESCRIPTION OF THE DRAWINGS

These and other advantages will become more apparent from the following detailed description of the various embodiments of the present disclosure with reference to the drawings wherein:

FIG. 1 is a schematic diagram of a system for creating, managing, sharing, and publishing a hierarchical list structure, according to an embodiment of the present disclosure;

FIG. 2 is a schematic diagram of an example application server forming part of the system of FIG. 1, according to an embodiment of the present disclosure;

FIG. 3 is a schematic diagram of an example client device forming part of the system of FIG. 1, according to an embodiment of the present disclosure;

FIGS. 4A, 4B, and 4D are examples of a user interface which may be displayed on the client device of FIG. 3, according to an embodiment of the present disclosure;

FIG. 4C depicts example icons which may be displayed on the user interface of FIGS. 4A, 4B, and 4D;

FIGS. 5A and 5B are further examples of a user interface which may be displayed on the client device of FIG. 3, according to an embodiment of the present disclosure; and

FIGS. 6A and 6B are yet further examples of a user interface which may be displayed on the client device of FIG. 3, according to an embodiment of the present disclosure.

### DETAILED DESCRIPTION

In the Summary section above, in this Detailed Description, in the Claims below, and in the accompanying drawings, reference is made to particular features (including method steps or acts) of the present disclosure. It is to be understood that the disclosure in this specification includes combinations of parts, features, or aspects disclosed herein. For example, where a particular feature is disclosed in the context of a particular aspect or embodiment of the present disclosure, or a particular claim, that feature can also be used, to the extent possible, in combination with and/or in the context of other particular aspects and embodiments of the present disclosure, and in the disclosure generally.

The term “comprises” and grammatical equivalents thereof are used herein to mean that other components, ingredients, steps, acts, etc. are optionally present. For example, an article “comprising (or “which comprises”) component A, B, and C can consist of (i.e., contain only) components A, B, and C, or can contain not only components, A, B, and C but also one or more additional components, elements, features, ingredients, steps, acts, etc.

Where reference is made herein to a method comprising two or more defined steps or acts, the defined steps or acts can be carried out in any order or simultaneously (except where the context excludes that possibility); and the method can include one or more other steps or acts which are carried out before any of the defined steps or acts, between two of the defined steps or acts, or after all the defined steps or acts (except where the context excludes that possibility).

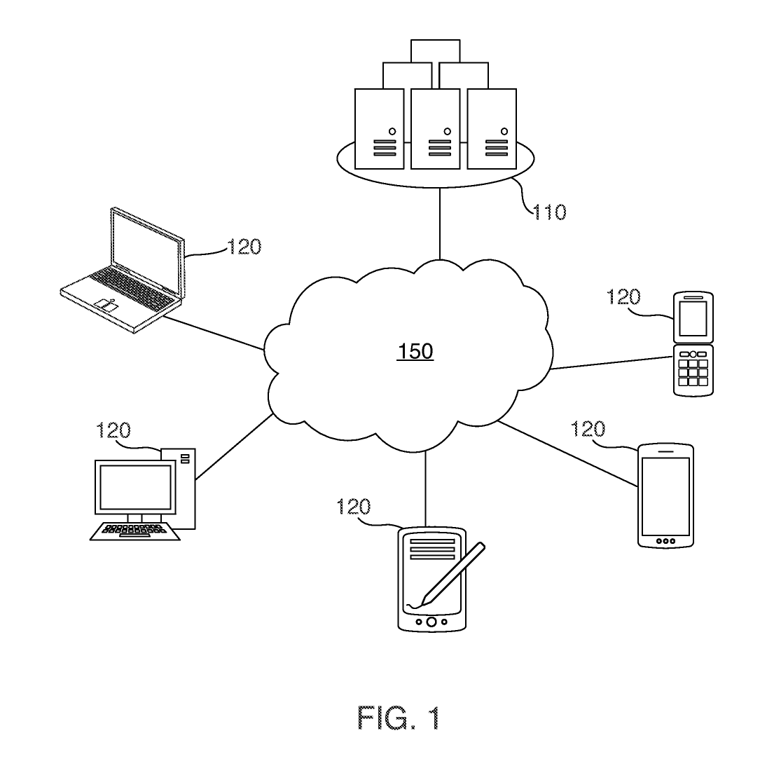

With reference to the drawings, FIG. 1 shows a diagram of an example system 100 for creating, managing, sharing, and publishing hierarchical list structures, according to an embodiment of the present disclosure. System 100 includes one or more application servers 110, one or more client devices 120, all connected to a network 150. As further described further below, application server 110 may be configured to host an application accessible to client device 120 via network 150. Network 150 may be any computer network known to those skilled in the art, including private networks, such as an intra-organizational network, and/or a public network, such as the Internet. Network 150 may be operated via any medium and protocol known to those skilled in the art, including wired and/or wireless configurations.

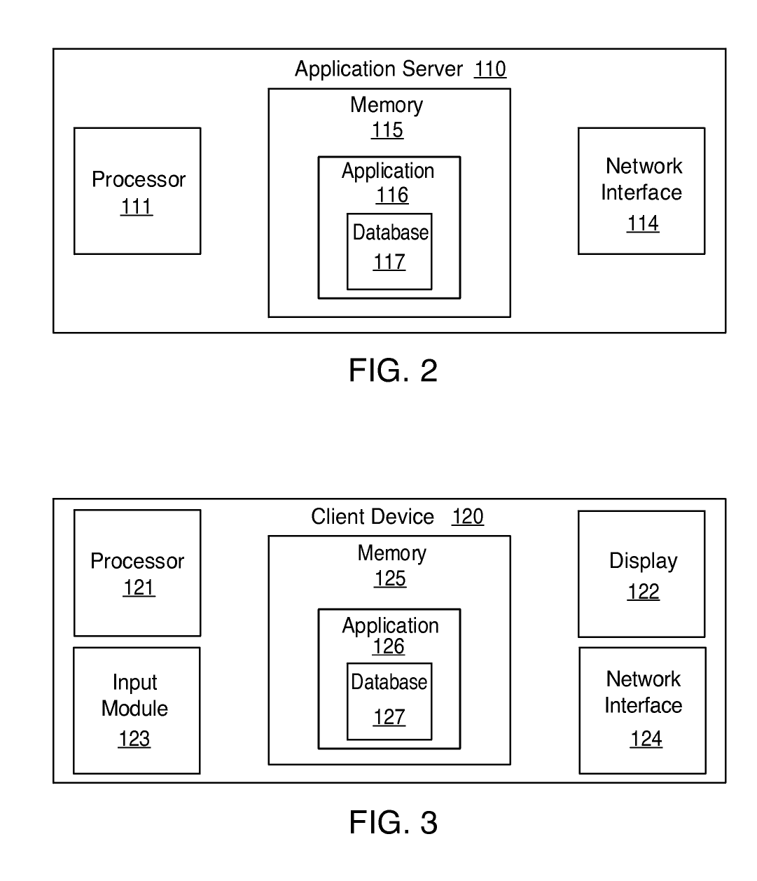

With reference to FIG. 2, there is shown a schematic diagram of application server 110 in accordance with the present disclosure. Application server 110 may be a single on-location server configured to operate on an organization's internal network, a single off-site server dedicated to a particular organization, a single off-site server serving multiple organizations, a single server accessible to the pubic, a series of servers operating in any of these configurations, a cloud-based server, or any other configuration or combination of these and other configurations known to those skilled in the art. Application server 110 may include a processor 111, a network interface 114, and a memory 115 storing an application 116. Application 116 may include a database 117. Network interface 114 may be connected to network 150, and may be one or more of a local area network (LAN) device, wide area network (WAN) device, a BLUETOOTH® device, a near-field communication (NFC) device, a cellular networking device using the global system for mobile communications (GSM), code division multiple access (CDMA), and/or other cellular networking standards, and/or any other networking devices known to those skilled in the art, and may be configured for wired and/or wireless communication.

Memory 115 may include one or more solid-state storage devices such as flash memory chips. Alternatively, or in addition to the one or more solid-state storage devices, memory 115 may include one or more mass storage devices connected to the processor 111 through a mass storage controller (not shown) and a communications bus (not shown). Although the description of computer-readable media contained herein refers to a solid-state storage, it should be appreciated by those skilled in the art that computer-readable storage media may be any available media that can be accessed by the processor 111. That is, computer-readable storage media may include non-transitory, volatile and non-volatile, removable and non-removable media implemented in any method or technology for storage of information such as computer-readable instructions, data structures, program modules or other data. For example, computer-readable storage media includes RAM, ROM, EPROM, EEPROM, flash memory or other solid state memory technology, CD-ROM, DVD, Blu-Ray or other optical storage, magnetic cassettes, magnetic tape, magnetic disk storage or other magnetic storage devices, or any other medium which can be used to store the desired information and which can be accessed by application server 110.

Application 116 may be a web-based application hosted by application server 110, which can be accessed by client device 120 via a web-browser application. Alternatively, application 116 may be a server-side application hosted by application server 110 and configured to operate with a client-side application run on client device 120.

Referring now to FIG. 3, there is shown a schematic diagram of a client device 100 which may be used by the user in accordance with the present disclosure. The client device 120 may be any one or more of a personal computer, desktop computer, laptop computer, tablet computer, smartphone, smartwatch, or any other type of computer known to those skilled in the art. Client device 120 may include a processor 121, a display 122, an input module 123, a network interface 124, and a memory 125 for storing an application 126. The processor 121 is configured to access the memory 125 in order to run the application 126. Application 126 may include a database 127. Input module 123 may be one or more of a keyboard, mouse, touchscreen, voice-command receiver, gesture receiver, camera, computer-vision interface, and/or any other user input device known to those skilled in the art. Network interface 124 may be connected to network 150, and may be one or more of a LAN device, a WAN device, a BLUETOOTH® device, an NFC device, a cellular networking device using the GSM, CDMA, and/or other cellular networking standards, and/or any other networking devices known to those skilled in the art, and may be configured for wired and/or wireless communication.

Memory 125 may include one or more solid-state storage devices such as flash memory chips. Alternatively, or in addition to the one or more solid-state storage devices, memory 125 may include one or more mass storage devices connected to the processor 121 through a mass storage controller (not shown) and a communications bus (not shown). Although the description of computer-readable media contained herein refers to a solid-state storage, it should be appreciated by those skilled in the art that computer-readable storage media may be any available media that can be accessed by the processor 121. That is, computer-readable storage media may include non-transitory, volatile and non-volatile, removable and non-removable media implemented in any method or technology for storage of information such as computer-readable instructions, data structures, program modules or other data. For example, computer-readable storage media includes RAM, ROM, EPROM, EEPROM, flash memory or other solid state memory technology, CD-ROM, DVD, Blu-Ray or other optical storage, magnetic cassettes, magnetic tape, magnetic disk storage or other magnetic storage devices, or any other medium which can be used to store the desired information and which can be accessed by client device 120.

Application 126 may be a native, client-side, application running on client device 120, and/or a web browser configured to open a web-based application hosted by a server, for example, application server 110, described above. Database 127 may store data related to application 126. For example, database 127 may store one or more elements, which include notes, photographs, pictographs, video recordings, audio recordings, and/or any other textual or multimedia elements known to those skilled in the art. The elements may be organized into one or more lists, as further described below. Database 127 may further store user account information, such as a user name, password, and/or account preferences related to a user of application 126. Database 127 may also store security and encryption settings related to one or more of the elements and/or lists, as further described below.

Described below are various example user interfaces of application 126 that may be displayed via display 122 of client device 120. Due to the differences in various platforms available at the time of filing the present application, it is envisioned that the user interface of application 126 may be different depending on the platform used by client device 120. While different user interfaces may be displayed on different platforms, the contents of the lists remain the same, and is available to be viewed on any platform on which a user logs in with his/her user account. For example, regardless of whether the user logs in to a desktop computer, laptop computer, tablet computer, or smartphone, the same lists associated with the active user account, and the same contents of those lists, are available on all platforms.

As used herein, the term “list” means a tree of elements having various levels and branches. That is, a list may have one or more “sub-lists,” where a sub-list is a “list-within-a-list” in a hierarchical tree. Further, a list may also have one or more elements at each level. Elements may be any of the data types described herein and further as known to those skilled in the art. Elements are entries of a list or sub-list, and may have included in the element, or attached to the element, one or more data types. For example, an element may include a photograph and/or a textual note. As another example, an element may have attached thereto a web link and/or a video file.

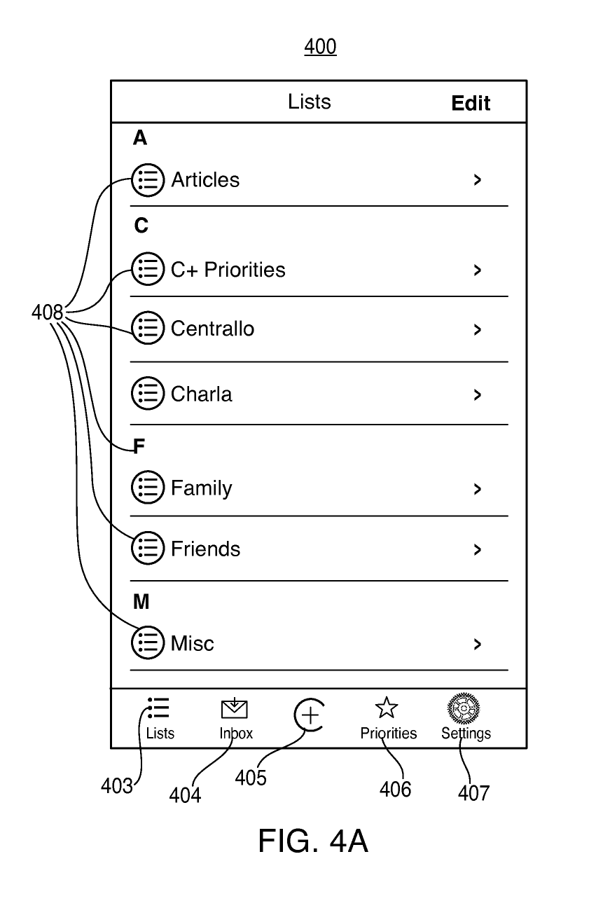

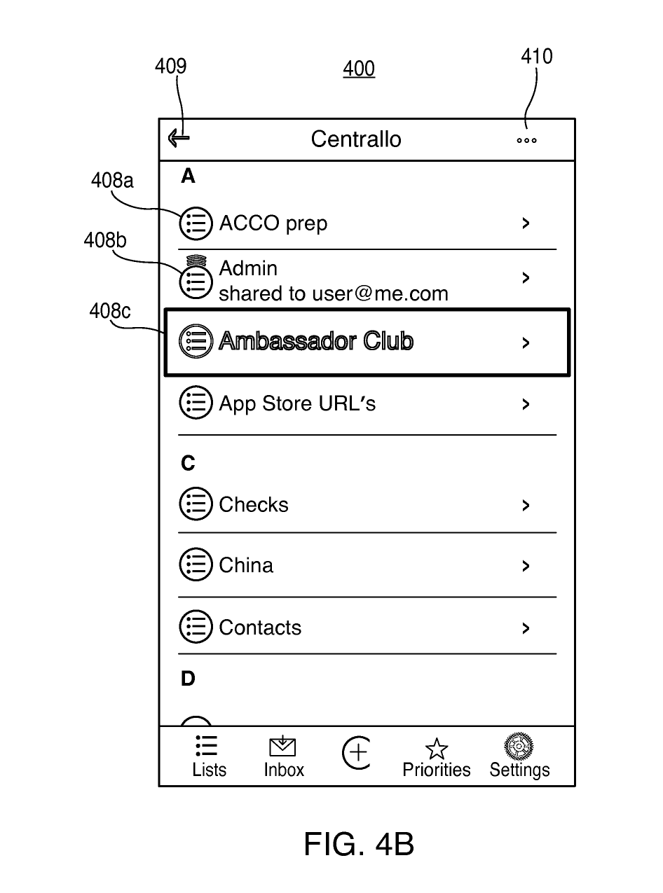

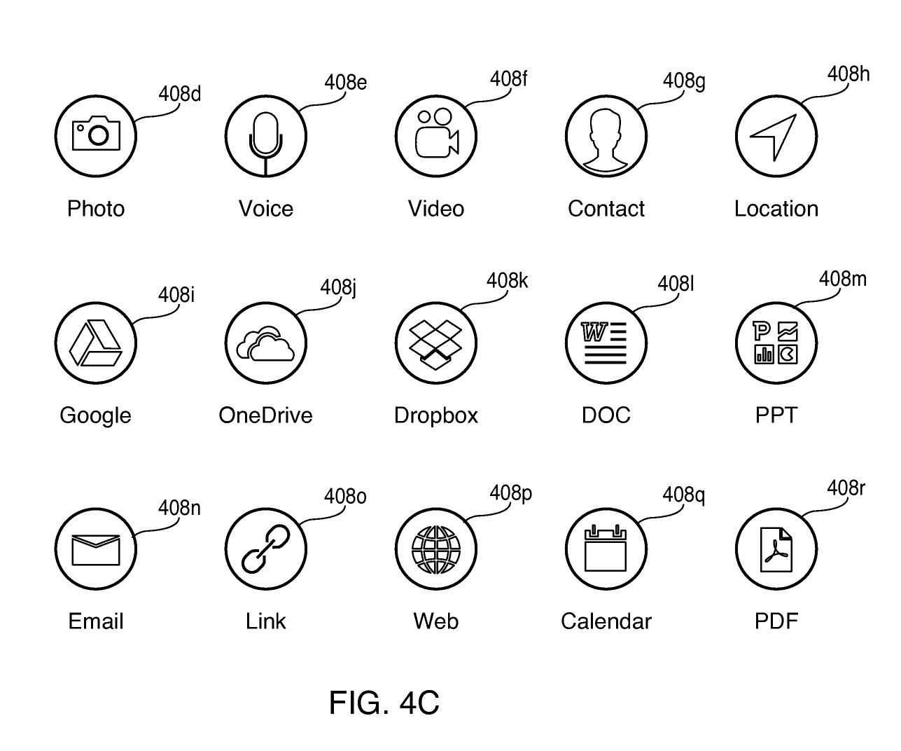

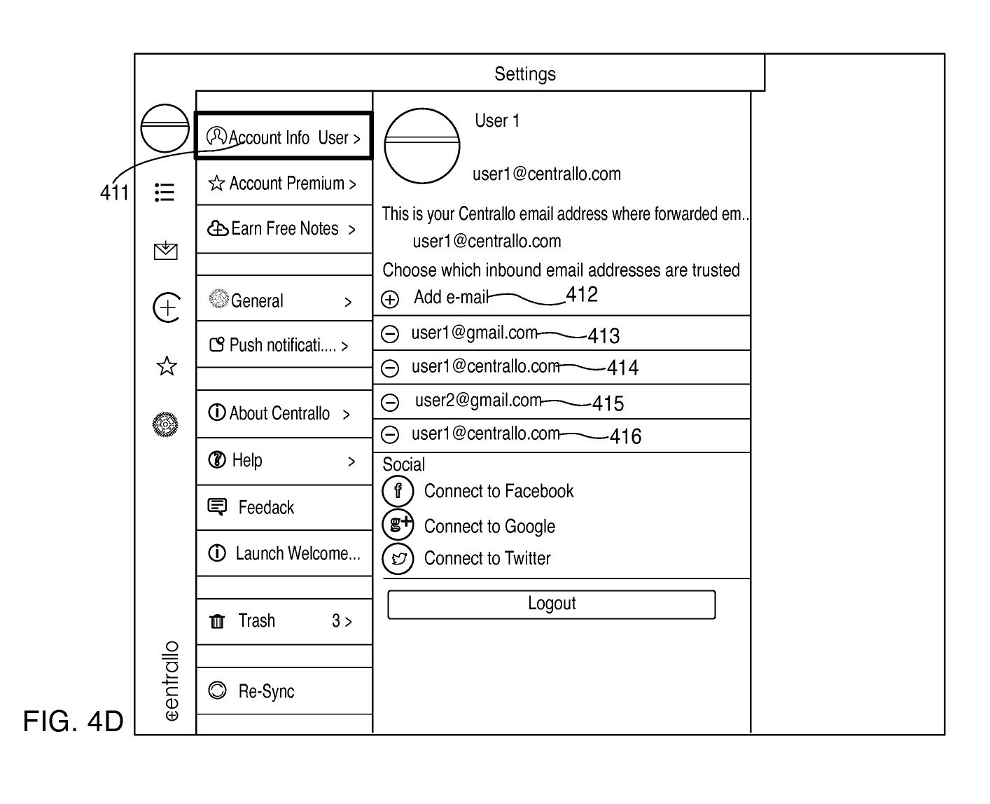

Referring now to FIG. 4A, there is shown an example user interface 400 which may be displayed via display 122 of client device 120 operating on a smartphone platform. User interface 400 may include a title 401 of the list being displayed. Title 401 will change depending on the list displayed. User interface 400 further includes various buttons.

Edit button 402, when selected by a user, allows the user to make changes to the list currently being displayed. For example, when the user selects edit button 402, application 126 allows the user to rename, reorganize, and/or delete any elements 408 shown in the list currently being displayed.

Lists button 403, when selected, displays the lists associated with the active user account. An important feature of the present disclosure is the concept of hierarchical lists, that is, lists within lists. While all lists are comprised of one or more elements, the present disclosure describes an application capable of having lists containing not only elements, but also sub-lists, and those sub-lists may in turn contain both elements or additional sub-lists, and so forth. Any list may have an infinite number of levels of sub-lists. In some embodiments, selecting lists button 403 returns user interface 400 to the top-most level of lists available. In other embodiments, selecting lists button 403 returns user interface to the last-viewed list regardless of the level within other lists.

Inbox button 404, when selected, displays elements 408 that have been added to the active user account but have not yet been assigned to a list. For example, when the user selects add element button 405, user interface 400 enables the user to create a new element 408. The element 408 may include text, photographs, pictographs, video recordings, audio recordings, digital contact cards, location data, documents such as word processor documents and spreadsheets, links to files stored in cloud-storage platforms, scanning files, email messages, and any other types of data known to those skilled in the art. Once the element 408 has been created, the user may immediately assign the element to a particular list, or may opt to save the element 408 to the inbox. In some embodiments, a newly created element 408 may by default be assigned to the currently displayed list. In addition, any list, sub-list, and/or element 408 may be moved from one level of a list or sub-list to another level of that list or sub-list, or to another list or sub-list at any time.

Further, any list, sub-list, and/or element 408 may be “dragged and dropped” onto another list, sub-list, or element 408 to form a new list or sub-list, wherein the “dragged and dropped” list, sub-list, or element 408 will be added to the list or sub-list onto which it is dropped at a level below that list or sub-list.

Priorities button 406, when selected, displays elements 408 that have been marked as priorities. Any element 408 on any level of any list may be marked as a priority, and will then be displayed when priorities button 406 is selected. An element 408 may be marked as a priority when it is created, when it is assigned to a list, or when it is viewed later.

Settings button 407, when selected, allows the user to change settings related to the active user account. Among other settings also available, the user may designate certain email addresses as trusted email addresses. For example, as shown in FIG. 4D, a settings menu 410 may have an Account Info section 411. Included in the Account Info section 411 may be an add trusted email button 412. Every user with an account to use application 126 is granted an email address associated with that user account. The user may add any number of trusted email addresses 413, 414, 415, 416 to the account. When an email message is received at the email address associated with the user account from a trusted email address 413, 414, 415, and/or 416, the received email message is added to the user's inbox which may be accessed by selecting inbox button 404. From there, the user may move the received email message to any list or sub-list to be added as an element 408 of that list or sub-list.

Referring now to FIG. 4B, there is shown another example user interface 400 which may be displayed via display 122 of client device 120 operating on a smartphone platform. In this example user interface 400, the “Centrallo” list shown in FIG. 4A has been selected, and the elements 408 of the “Centrallo” list is being displayed.

Different types of elements 408 may have different icons indicating their status. For example, an element 408 that is a sub-list may have a list icon 408a, while an element that is shared with other user accounts may have a shared icon 408b, and an element that has been marked as a priority may have a priority icon 408c. Further, as shown in FIG. 4C, various data types may have associated therewith various different icons. For example, a photograph may have a photo icon 408d, an audio recording may have a voice icon 408e, a video recording may have a video icon 408f, a digital contact card may have a contact icon 408g, location information may have a location icon 408h, a link to a document stored on GOOGLE DRIVE® may have a GOOGLE® icon 408i, a link to a document stored on MICROSOFT ONEDRIVE® may have a ONEDRIVE® icon 408j, a link to a document stored on DROPBOX® may have a DROPBOX® icon 408k, a text document may have a doc icon 408l, a slide show file may have a ppt icon 408m, an email message may have an email icon 408n, a link may have a link icon 408o, a URL may have a web icon 408p, a calendar file may have a calendar icon 408q, or a portable document format file may have a pdf link 408r. In addition to help the user easily distinguish between data types, icons also function as shortcuts to opening content included in or attached to an element 408. For example, when selecting an element, from a list, as shown in FIG. 2B, selecting the icon, by either tapping, clicking, or otherwise interfacing directly with the icon, application 126 will open the content of the element 408, while selecting another part of the element 408, such as a textual description part and/or white space part, will open the element 408 to show its contents but not open the contents directly. For example, an element 408 including a URL and will have a web icon 408p, and thus, when the user selects the web icon 408p, application 126 will cause a web browser installed on client device 120 to open the URL included in the element 408. In another example, an element 408 having attached thereto a video recording will have a video icon 408f, such that when the user selects the video icon 408f, application 126 will cause client device 120 to open the video recording. However, when the user selects a textual description part of element 408 having attached thereto a video recording, application 126 will simply open element 408 showing that there is a video recording attached to element 408, but will not automatically start playing the video recording. Thus, icons, as described herein, function both as indicators of the data type included in or attached to elements 408, and as shortcuts to opening the data included in or attached to elements 408.

A back button 409, when selected, returns user interface to the previously displayed view, typically the list one level higher than that which is currently displayed.

Options button 401, when selected, allows the user to select various optional functions to be performed with an element of the currently displayed list. For example, the user may share an element or a list with another user.

A list, sub-list, or element may be shared at any level, and the same list may be shared at different levels with different other users. For example, the user may opt to share the top level of a list with one other user, a sub-list located 2 levels down from the top level with a second other user, and a single element located 4 levels down from the top level with a third other user. The third other user will only be able to access the single element located 4 levels down from the top level, but the second other user will be able to access all elements and sub-lists located below the second level, including the element located 4 levels down. When a list is shared with another user, that user may choose to simply view the shared list, or add the shared list to his/her account. In some embodiments, a shared list which is added to multiple accounts can be changed, added to, and/or deleted by any user having access to the list. In other embodiments, the user who shares a list sets permissions for each other user with whom the list is shared, and may thus restrict the actions and/or changes other users may perform with the shared list.

Any list, sub-list, or element at any level may be locked with a password. If a list, sub-list, or element is locked, it can only be accessed after the password is entered. If that list, sub-list, or element is shared, or is located within a shared list or sub-list, the user(s) with whom it is shared must also first enter the password before being able to access that list, sub-list, or element. In an embodiment, the lock is level specific, meaning that access is only restricted at that level, but if a sub-list or element located below the locked level is shared, the user(s) with whom that sub-list or element is shared may access it without entering the password. In another embodiment, the same list or sub-list may be locked at different levels with different passwords.

Any list, sub-list, or element at any level may be published. When a list, sub-list, or element is published, a uniform resource locator (URL) is generated. The user may send the URL to any person, and that person will be able to view the published list, sub-list, or element when accessing the URL with a web browser. A published list or sub-list includes all the sub-lists and elements below the level at which it is published, and all those sub-lists and elements will be accessible via the URL. The same locking protections apply to published lists as to shared lists. In addition to publishing a list with a URL accessible via a web browser, lists may also be published to other platforms, including social media platforms.

Any element may be saved to client device 120. For example, any textual note, photograph, pictograph, video recording, audio recording, digital contact card, or location information may be saved to memory 125 outside of application 126 and become accessible to the user of client device 120 without opening application 126.

Any list, sub-list, and/or element at any level may be printed to a printer associated with client device 120.

Any list, sub-list, and/or element at any level may be sent to another person, either as a URL or as a direct link.

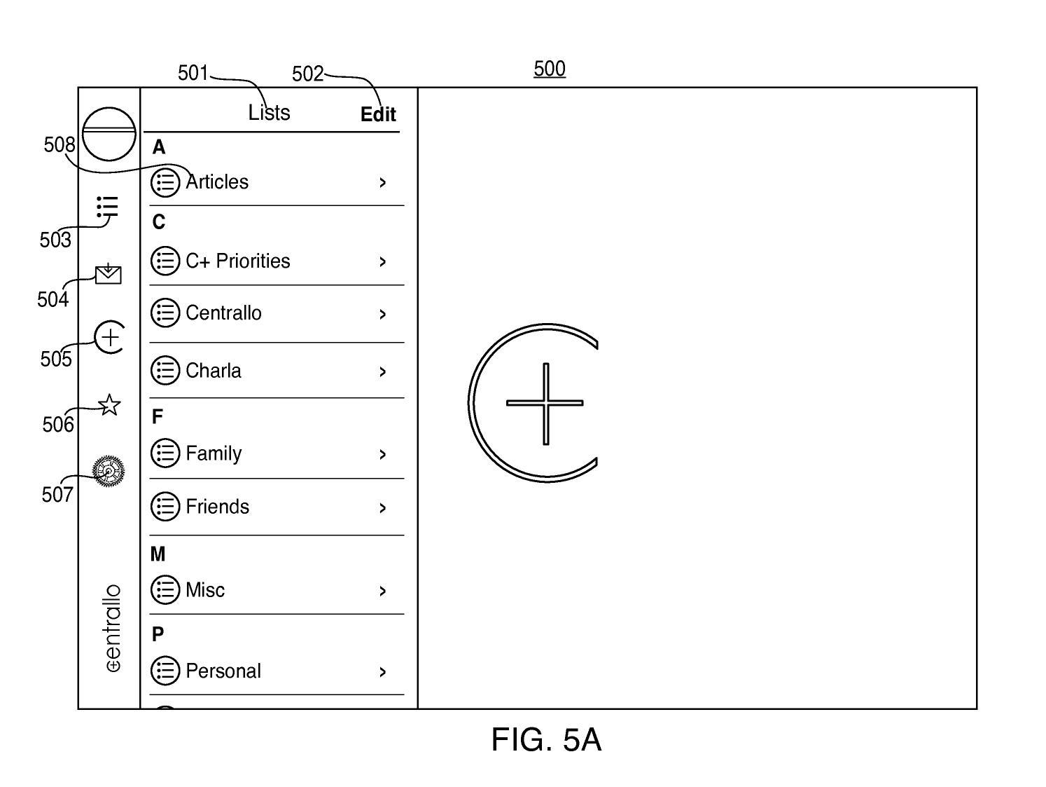

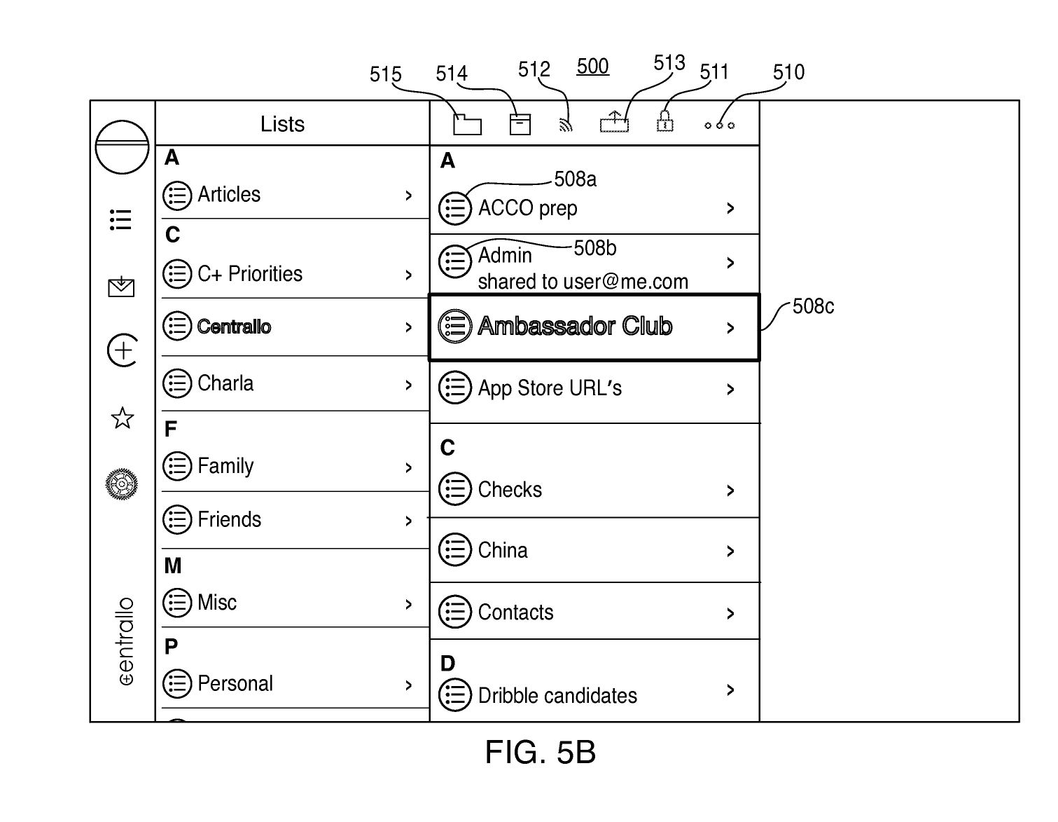

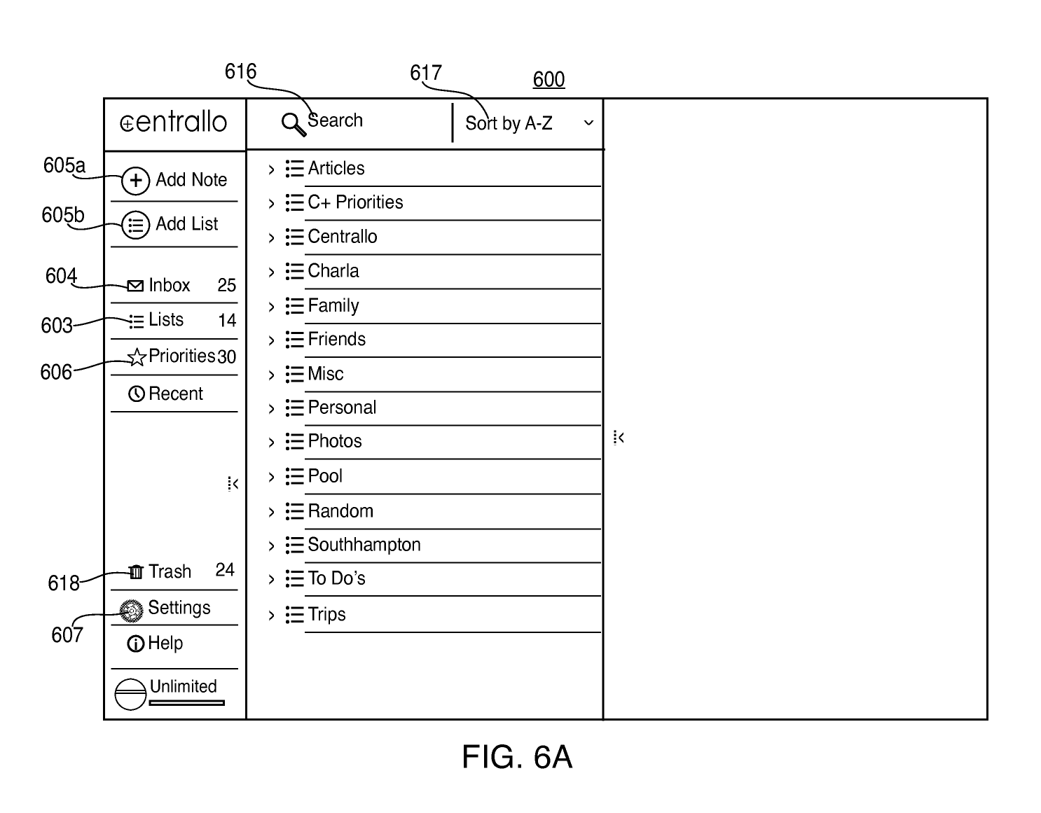

Referring now to FIG. 5A, there is shown an example user interface 500 which may be displayed via display 122 of client device 120 operating on a tablet computer platform. While the graphical layout of user interface 500 is different from user interface 400 described above with reference to FIGS. 4A and 4B, the functionality is similar, and where similarly named buttons are described, the description of the corresponding functionality will not be repeated for purposes of brevity.

User interface 500 may include a title 501, edit button 502, lists button 503, inbox button 504, add element button 505, priorities button 506, and settings button 507. Each list may again have an infinite number of sub-lists and/or elements 508.

Referring now to FIG. 5B, there is shown another example user interface 500 which may be displayed via display 122 of client device 120 operating on a tablet computer platform. Similar to what was described with reference to FIG. 4B above, in this example user interface 500, the “Centrallo” list shown in FIG. 5A has been selected, and the elements 508 of the “Centrallo” list is being displayed. Elements 508 may have different icons indicating their status, such as list icon 508a, shared list icon 508b, and priority element 508c. User interface 500 also includes options button 510, lock button 511 corresponding to the locking functionality described above, share button 512 corresponding to the sharing functionality described above, send button 513 corresponding to the sending functionality described above, print button 514 corresponding to the printing functionality described above, and save button 515 corresponding to the saving functionality described above.

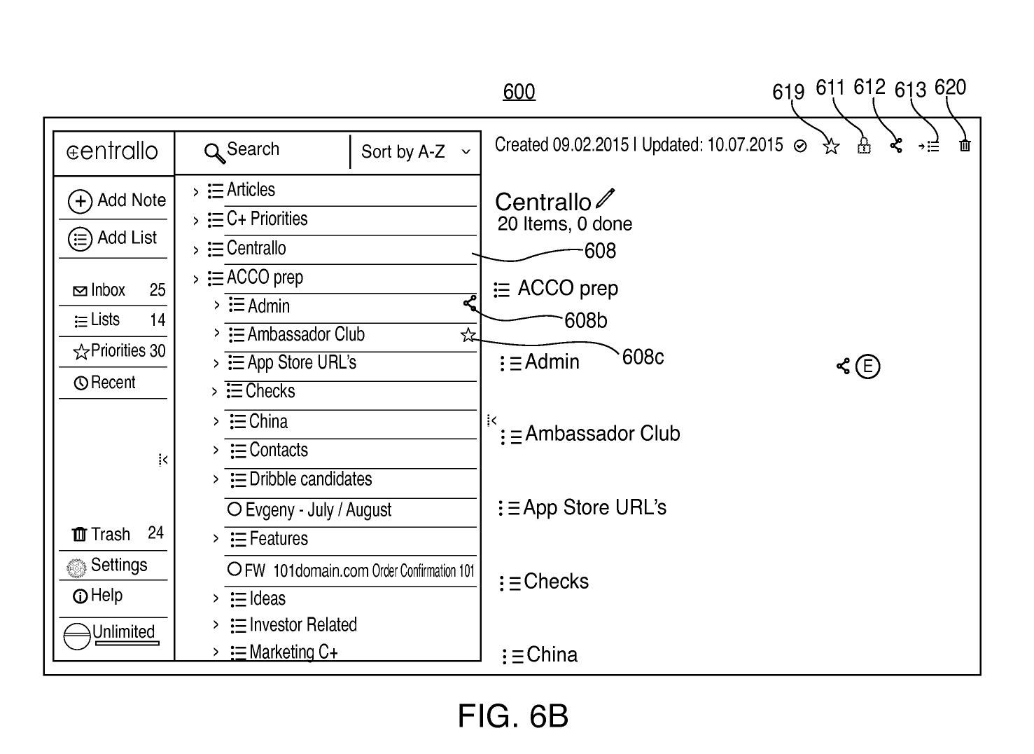

Referring now to FIG. 6A, there is shown an example user interface 600 which may be displayed via display 122 of client device 120 operating on a web browser platform. While the graphical layout of user interface 600 is different from user interface 400 and user interface 500 described above with reference to FIGS. 4A, 4B, 5A, and 5B, the functionality is similar, and where similarly named buttons are described, the description of the corresponding functionality will not be repeated for purposes of brevity.

User interface 600 lists button 603, inbox button 604, add note button 605a, add list button 605b, priorities button 606, and settings button 607. Each list may again have an infinite number of sub-lists and/or elements 608. In addition, user interface 600 may include a trash button 618 which, when selected, displays elements 608 that have been removed from lists. User interface 600 may also include a search field 616 allowing the user to search for a particular list, sub-list, element, or data contained in an element. Further, user interface 600 allows the user to select the criteria by which lists are sorted by selecting sorting menu 617.

Referring now to FIG. 6B, there is shown another example user interface 600 which may be displayed via display 122 of client device 120 operating on a web browser platform. Similar to what was described with reference to FIGS. 4B and 5B above, in this example user interface 600, the “Centrallo” list shown in FIG. 6A has been selected, and the elements 608 of the “Centrallo” list is being displayed. Elements 608 may have different icons indicating their status, such as shared icon 608b, and priority icon 608c. User interface 600 also includes lock button 611 corresponding to the locking functionality described above, share button 612 corresponding to the sharing functionality described above, send button 613 corresponding to the sending functionality described above, priority button 619, which, when selected, marks a list or element as a priority, and delete button 620, which, when selected, moves a list or element to the trash.

Although the present disclosure has been described in considerable detail with reference to certain preferred version thereof, other versions are possible and contemplated. Therefore, the spirit and scope of the appended claims should not be limited to the description of the preferred versions contained therein.

While lists are created, updated, and changed via client device 120, a representative copy of all lists, sub-lists, and elements included in any list at any level may be stored on application server 110, such that application server 110 may automatically update all client devices 120 associated with a particular user account in order for all client devices to be kept up-to-date.

Additionally, any lists, sub-lists, and/or elements shared between multiple user accounts may also be kept in-sync such that any changes made by any user with access to a shared list will automatically be updated to application server 110, from where the changed list, sub-list, and/or element is automatically updated on all client devices 120 with access to that list, sub-list, or element.

Similarly, when a list, sub-list, or element is published, whether via a URL, social media platform, or other medium, application server 110 automatically updates that published list, sub-list, or element with changes made via client device 120.

Any element in a claim that does not explicitly state “means for” performing a specified function or “step for” performing a specified function, is not to be interpreted as a “means” or “step” clause as specified in 35 U.S.C. §112(f). In particular, the use of “step of” in the claims is not intended to invoke the provisions of 35 U.S.C. §112(f).

What is claimed is:

1. A system for creating, managing, sharing, and publishing a hierarchical list structure, the system comprising:
a server configured to host an application; and
a first client device connected to the server via a network, the first client device configured to interface with the application hosted by the server to:
create a list including a sub-list; and
associate one or more data elements with the sub-list,
wherein the one or more data elements are entries of the sub-list, and the sub-list is an entry of the list, and
wherein the list, the sub-list, and the data elements are stored on the server.

2. The system according to claim 1, further comprising a second client device, and wherein the first client device is further configured to share the list with the second client device.

3. The system according to claim 2, further comprising a third client device, and wherein the first client device is further configured to share the sub-list with the third client device.

4. The system according to claim 1, wherein the first client device is further configured to mark one of the data elements as a priority to make it a prioritized element, and wherein the client device adds the prioritized element to a priorities view where the prioritized element can be viewed without navigating through the list and sub-list.

5. The system according to claim 3, wherein the first client device is further configured to lock the sub-list with a password, and
wherein the third client device is required to enter the password before being granted access to the locked sub-list.

6. The system according to claim 1, wherein the first client device is further configured to publish the list to a social media platform, wherein the publication to the social media platform includes the list, the sub-list, and the data elements.

7. The system according to claim 3, wherein the first client device is further configured to update the list, the sub-list, and the data elements on the server with any changes made to any of the list, the sub-list, or the data elements via the first client device.

8. A method of creating, managing, sharing, and publishing a hierarchical list structure, the method comprising:
creating, via a first client device, a list including a sub-list; and
associating one or more data elements with the sub-list,
wherein the one or more data elements are entries of the sub-list, and the sub-list is an entry of the list, and
wherein the list, the sub-list, and the data elements are stored on a server.

9. The method according to claim 8, further comprising sharing the list with a second client device.

10. The method according to claim 9, further comprising sharing the sub-list with a third client device.

11. The method according to claim 8, further comprising:
marking one of the data elements as a priority to make it a prioritized element,
wherein the prioritized element is added to a priorities view where the prioritized element can be viewed without navigating through the list and sub-list.

12. The method according to claim 10, further comprising:
locking the sub-list with a password,
wherein the third client device is required to enter the password before being granted access to the locked sub-list.

13. The method according to claim 8, further comprising:
publishing the list to a social media platform,
wherein the publication to the social media platform includes the list, the sub-list, and the data elements.

14. The method according to claim 10, further comprising updating the list, the sub-list, and the data elements on the server with any changes made to any of the list, the sub-list, or the data elements via the first client device.

15. A non-transitory computer-readable storage medium storing a program for creating, managing, sharing, and publishing a hierarchical list structure, the program including computer-executable instructions which, when executed by a processor, causes a first client device to:
create a list including a sub-list; and
associate one or more data elements with the sub-list,
wherein the one or more data elements are entries of the sub-list, and the sub-list is an entry of the list, and
wherein the list, the sub-list, and the data elements are stored on a server.

16. The non-transitory computer-readable storage medium according to claim 15, wherein the instructions further cause the first client device to share the list with a second client device.

17. The non-transitory computer-readable storage medium according to claim 16, wherein the instructions further cause the first client device to share the sub-list with a third client device.

18. The non-transitory computer-readable storage medium according to claim 15, wherein the instructions further cause the first client device to:
mark one of the data elements as a priority to make it a prioritized element,
wherein the prioritized element is added to a priorities view where the prioritized element can be viewed without navigating through the list and sub-list.

19. The non-transitory computer-readable storage medium according to claim 17, wherein the instructions further cause the first client device to:
lock the sub-list with a password,
wherein the third client device is required to enter the password before being granted access to the locked sub-list.

20. The non-transitory computer-readable storage medium according to claim 17, wherein the instructions further cause the first client device to update the list, the sub-list, and the data elements on the server with any changes made to any of the list, the sub-list, or the data elements via the first client device.
